(19) United States
(12) Patent Application Publication
(10) Pub. No.: US 2024/0318612 A1
(43) Pub. Date: Sep. 26, 2024

(54) ELECTROMAGNETOCHEMICAL METHODOLOGY FOR CURING STEEL ALLOYS AGAINST HYDROGEN PERMEATION AND EMBRITTLEMENT IN THE MANUFACTURE OF STIRLING ENGINES

(71) Applicants: Mirley K. Balasubramanya, San Antonio, TX (US); J. Harold Idell, Sedona, AZ (US); Joseph Shae McDowell, San Antonio, TX (US); Kevin M. Chandler, San Antonio, TX (US)

(72) Inventors: Mirley K. Balasubramanya, San Antonio, TX (US); J. Harold Idell, Sedona, AZ (US); Joseph Shae McDowell, San Antonio, TX (US); Kevin M. Chandler, San Antonio, TX (US)

(73) Assignee: Quantum Industrial Development Corporation, San Antonio, TX (US)

(21) Appl. No.: 18/419,516

(22) Filed: Jan. 22, 2024

Related U.S. Application Data
(60) Provisional application No. 63/440,098, filed on Jan. 20, 2023.

(51) Int. Cl. F02G 1/053

(52) U.S. Cl. CPC F02G 1/053

(57) ABSTRACT

A Stirling cycle engine with resistance to hydrogen permeation and embrittlement is disclosed, along with methods for manufacturing the same. In a preferred embodiment, an oxide coating is applied as an affinity barrier on the inner surfaces of the gas circuit which may minimize hydrogen permeation and embrittlement. The oxide coating may be in the form of magnetite (Fe₃O₄) which may bond to the surfaces of the steel alloys of the gas circuit. This process employs an electromagnetochemical technique such that the formation of ferrimagnetic iron-oxide crystals align along applied magnetic field lines to enhance the formation of larger and more durable crystal growth, thus reducing the number of interstitial gaps between crystals which are present when other oxide coating techniques are employed. This methodology may require a 100 hour continuous operation of the Stirling Cycle while an electric current and magnetic field, parallel to the electric current, are applied to the Stirling Cycle engine.

The application claims the benefit of priority from U.S. provisional application No. 63/440,098, filed Jan. 20, 2023, having the same inventors and title, and which is incorporated herein by referenced in its entirety.

### FIELD OF THE DISCLOSURE

The present disclosure pertains generally to external combustion engines, and more particularly to such engines having gas circuits whose inner surfaces are equipped with affinity barriers to prevent or minimize hydrogen permeation or embrittlement.

### BACKGROUND OF THE DISCLOSURE

Some Stirling cycle engines use hydrogen under high pressure as the motive gas to sustain the Stirling cycle. The use of hydrogen is advantageous because of its superior heat exchange properties. However, hydrogen is known to cause embrittlement of ferrous alloys as a consequence of hydrogen permeation. Other motive gases, such as CFCs, do not cause hydrogen embrittlement, but are not suitable for use in Stirling cycle engines due to their tendency to undergo chemical dissociation at the operating temperatures typical for Stirling cycles. Helium does not cause embrittlement and is not prone to chemical disasociation at the operating temperatures typical for Stirling cycles, but has less favorable heat exchange properties compared to hydrogen.

Some metals, such as aluminum, are resistant to hydrogen embrittlement. However, the use of aluminum in Stirling cycle engines is not feasible because the melting point of aluminum is below the typical operating temperatures for Stirling cycles. Moreover, aluminum is too ductile to accommodate the high pressures typical for hydrogen motive gas in a Stirling cycle engine unless the metal is used at thicknesses which would negatively impact the thermal energy transfer rates and which would increase the weight to horsepower ratio of the engine.

The problem of hydrogen permeation and embrittlement in not unique to Stirling cycle engines. Hydrogen permeation and embrittlement has been a problem in the aerospace industry because of the common reliance on liquid hydrogen as a fuel for rocket engines. Various methods for accommodating the effects of hydrogen permeation have been successfully employed in these applications. However, these solutions as implemented are not viable at the temperature ranges that are typically encountered in Stirling cycle engines.

### SUMMARY OF THE DISCLOSURE

In one aspect, a method is provided for making a Stirling engine. The method comprises (a) providing a Stirling engine which has an engine block with a gas circuit defined therein for a motive gas, said gas circuit having a surface which is exposed to the flow of said motive gas and which comprises a steel alloy; (b) disposing a first motive gas in said gas circuit, said first motive gas containing at least one oxygen-containing compound; and (c) operating the Stirling engine.

In another aspect, a method for making a Stirling engine is provided. The method comprises (a) providing a metal conduit having an interior surface and an exterior surface; (b) applying an oxide coating to the interior surface of the metal conduit, thereby creating an oxide affinity barrier on said interior surface; and (c) incorporating the metal conduit into the gas circuit of a Stirling cycle engine.

In a further aspect, a Stirling engine is provided which comprises (a) an engine block; and (b) a gas circuit defined in said engine block and having a motive gas disposed therein, said gas circuit having a surface which is exposed to said motive gas and which comprises a steel alloy; wherein said motive gas contains hydrogen and at least one oxygen-containing compound.

In still another aspect, a Stirling engine is provided which comprises (a) an engine block; and (b) a gas circuit defined in said engine block and having a hydrogen-containing motive gas disposed therein, said gas circuit having a surface which is exposed to said motive gas and which comprises a steel alloy with an oxide affinity barrier disposed thereon; wherein said motive gas contains hydrogen and at least one oxygen-containing compound.

### BRIEF DESCRIPTION OF THE DRAWINGS

FIG. 1 is an embodiment of a Stirling engine disclosed in U.S. Pat. No. 7,168,248 (Sakamoto et al.).

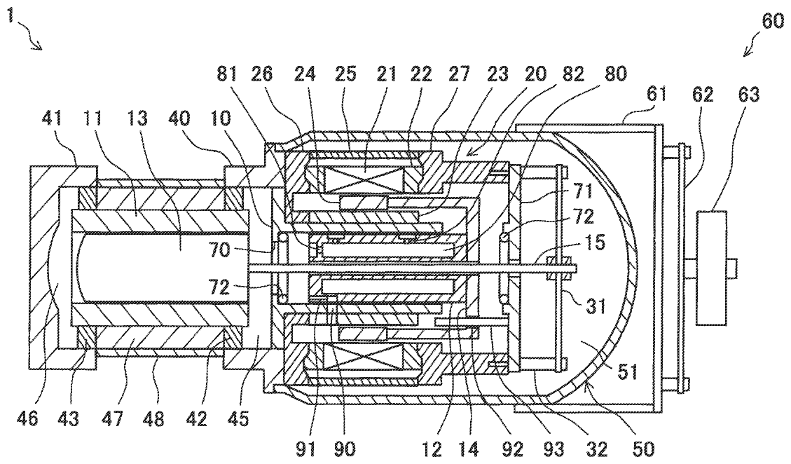

### DETAILED DESCRIPTION OF THE DISCLOSURE

Hydrogen embrittlement differs significantly from of other types of steel corrosion. The permeation and subsequent embrittlement of steel by hydrogen extends beyond the surface and deep into the matrix of the steel alloy. By contrast, simple oxidation (e.g., rusting) of steel alloys is typically a surface phenomenon. Partly for this reason, stainless steel alloys are not immune to the effects of hydrogen embrittlement, even though these alloys are resistant to rusting.

Similarly, many of the anti-corrosion treatments and techniques developed for other applications are ineffective in preventing hydrogen permeation and embrittlement. For example, in the maritime industry, metal ship hulls are often galvanized to protect them against corrosion. The zinc coating conferred by these processes is effective in inhibiting oxidation (rusting) of the steel by actively reversing the natural electrical current flow. However, such a technique is not effective in inhibiting nor preventing hydrogen permeation and subsequent embrittlement.

Other techniques for imparting corrosion resistance to metal include the formation of oxide coatings thereon. For example, oxide coatings are frequently utilized in the firearms industry to prevent corrosion of steel components. One of these techniques is the bluing of steel surfaces to inhibit the formation of Fe₂O₃ (rust) thereon by forming a layer of magnetite (Fe₃O₄ or FeFe₂O₄). This layer is typically just a few molecules thick of randomly oriented, octahedral crystals of Fe₃O₄.

The process of hydrogen permeation is a problem of geometry at the molecular scale. Hydrogen embrittlement of steel alloys is a consequence of the nanostructures of the steel alloy and the boundary layers between the grains of the metal. At the molecular scale, hydrogen can easily permeate through the steel alloys by way of the interstitial gaps between the various crystal structures and along the grain boundaries in the matrix of the alloy.

The process of making steel typically involves quenching the steel to prevent large crystal growth. This process gives rise to numerous small, randomly oriented crystal structures and grain boundaries. The resulting random orientation improves the shear strength of the alloy by preventing large scale fracturing along large crystal planes. However, it also results in the formation of numerous interstitial gaps through which hydrogen can permeate. While it may be possible to overcome this issue by promoting larger crystal growth within the matrix of the alloy and thereby reducing the number of interstitial gaps (e.g., by reducing or eliminating quenching), doing so would likely come at the cost of reduced shear strength in the steel alloy.

Some metal alloys, such as cobalt steel, exhibit resistance to hydrogen embrittlement. However, due to its scarcity and high cost, cobalt steel is not an economically practical solution to the problem of hydrogen permeation and embrittlement in Stirling cycle engines.

The problem may be further appreciated from a chemical perspective. At the molecular scale, the bond length of molecular hydrogen (H₂) is 74.13 μm. This is exceedingly small compared to the body centered cubic (BCC) arrangement of iron (Fe) atoms common in the crystal lattice of steel alloys. The Fe atoms in this BCC structure are disposed at the center and vertices of a cube with regular bond lengths of 248.2 μm. This distance is more than three times the bond length of molecular hydrogen. The crystal dimensions do not appreciably change for carbon steel, since the addition of carbon to the lattice structure simply displaces the iron atom in the center of the cube. Given the significantly smaller bond length of molecular hydrogen compared to iron, it is clear that inhibiting hydrogen permeation cannot be achieved simply by trying to fill the interstitial gaps within the matrix of the steel alloy.

Since hydrogen is the preferred motive gas for the mass production of Stirling cycle engines, and steel alloys are the preferred materials for fabrication of these engines, the problems of hydrogen permeation and embrittlement must be resolved in order for mass produced Stirling cycle engines to be viable in the marketplace.

It has now been found that the foregoing need may be met with the methodologies and devices disclosed herein. In a preferred embodiment, an affinity barrier is created on surfaces of a Stirling cycle engine which are prone to hydrogen permeation and embrittlement as, for example, through the creation of a suitable oxide coating on these surfaces. Since hydrogen has an affinity for various oxide coatings, it becomes entrapped in the affinity layer and is prevented from permeating into the matrix of the steel alloy. Consequently, Stirling engines made with this approach can leverage the excellent mechanical properties of steel alloys, and can be used with hydrogen as the motive gas without suffering from hydrogen permeation and embrittlement.

In one exemplary embodiment of the methodologies disclosed herein, after final assembly of a Stirling cycle engine, the hydrogen motive gas is mixed with carbon dioxide (CO₂) at less than 2% by volume. Once the engine has been fully pressurized with the H₂/CO₂ mixture, the Stirling cycle is initiated to circulate the motive gas throughout the gas circuit of the engine while under pressure and at the normal operating temperature (which, as previously noted, may reach or exceed 850° C.). Without wishing to be bound by theory, the application of an electrical current and magnetic field to the engine block may facilitate crystal formation and alignment of the octahedral crystals of Fe₃O₄ such that the formation of interstitial gaps in the oxide coating may be minimized. This oxide barrier on the surface of the steel alloy may create an affinity barrier such that the hydrogen permeation may be inhibited (e.g., by the attraction of the hydrogen molecules to the oxygen atoms in the affinity barrier), thereby reducing hydrogen leakage, permeation and subsequent embrittlement. By conducting the curing process in the presence of both an electric current and a magnetic field, the oxide surface coating may have a more durable bond to the steel alloy substrate of the gas circuit.

Without wishing to be bound by theory, preferred embodiments of the methodology disclosed herein are believed to reduce or minimize interstitial gaps between the octahedral crystal structures of Fe₃O₄, since the ferrimagnetic nature of the octahedral crystals will tend to cause them to align along the magnetic field lines. This results in more uniform and ordered large scale crystal structures. The application of an oxide coating to steel alloys, by applying both an electric current and a magnetic field (which is preferably parallel to the electric current) is novel in the field of Stirling cycle engine manufacturing. The embodiment of this methodology is a preferred process for the final curing of the steel alloys used in the manufacture of the gas circuit of a Stirling cycle engine to reduce, minimize or eliminate hydrogen leakage, permeation and embrittlement. The magnetic field may be sustained by a plurality of permanent magnets or by one or more electric solenoid wire coils.

While formation of an oxide layer through the interaction of CO₂ with the metal substrate of the Stirling engine is preferred, it will be appreciated that a similar approach may be utilized to deposit other types of coating materials on various types of substrates, and that a more rapid crystal growth may be induced when both a magnetic field and an electric current are applied. This electromagnetochemical technique may promote relatively large octahedral crystal growth of magnetite oxide, thereby minimizing the number of interstitial gaps in the coating and improving its durability.

After the final assembly of a Stirling cycle engine, the gas circuit of the engine may be pressurized to 185 bar with hydrogen mixed with less than 2% CO₂ by volume. The Stirling cycle may then be initiated after the gas circuit in the engine has been pressurized with the motive gas mixture. The Stirling cycle may be run for a period of one hundred hours at a temperature which may reach 850° C. The doping of hydrogen with CO₂ may allow oxygen atoms in the motive gas mixture to bond with the surface of the steel alloy on the interior surfaces of the gas circuit of the engine, thereby forming an oxide coating composed of Fe₃O₄ on these surfaces. This process may include the application of a direct current (DC) through the engine block. The DC current is preferably less than two amperes.

To take advantage of the ferrimagnetic nature of Fe₃O₄, a magnetic field may also be applied in the region of the engine block during the curing process. The magnetic field may be produced by a plurality of permanent magnets parallel to the electric current and/or through the application of a plurality of solenoid electric wire coils. In the region of the engine block, the magnetic field strength is preferably less than 0.5T. The application of the magnetic field may help to align the crystals of Fe₃O₄ such that they orient along the magnetic field lines, thus minimizing the random orientation of the crystal units and reducing the overall number of interstitial gaps in the matrix of the oxide surface coating of the steel alloys. The technique of applying the oxide coating to the steel alloys with this electromagnetochemical technique may result in a significantly more durable bonding of the oxide with the surfaces of the steel alloys and with significantly more order along the crystal unit boundaries than a technique that relies on an oxide formation without an electric current and a magnetic field. Upon the conclusion of the curing process, the engine motive gas may be vented.

The above description of the present invention is illustrative and is not intended to be limiting. It will thus be appreciated that various additions, substitutions and modifications may be made to the above described embodiments without departing from the scope of the present invention. Accordingly, the scope of the present invention should be construed in reference to the appended claims.

1. A Stirling engine, comprising:
an engine block; and
a gas circuit defined in said engine block and having a hydrogen-containing motive gas disposed therein, said gas circuit having a surface which is exposed to said motive gas and which comprises a steel alloy with an oxide affinity barrier disposed thereon.

2. The Stirling engine of claim 1, wherein the affinity barrier comprises magnetite (Fe₃O₄).

3. The Stirling engine of claim 1, wherein said motive gas comprises hydrogen.

4. The Stirling engine of claim 1, wherein the Stirling engine creates a maintained Stirling cycle, and wherein the operating temperature of the sustained Stirling Cycle is at least 600° C.

5. The Stirling engine of claim 1, wherein the Stirling engine creates a maintained Stirling cycle, and wherein the operating temperature of the sustained Stirling Cycle is at least 700° C.

6. The Stirling engine of claim 1, wherein the Stirling engine creates a maintained Stirling cycle, and wherein the operating temperature of the sustained Stirling Cycle is at least 850° C.

7. The Stirling engine of claim 1, wherein the Stirling engine creates a maintained Stirling cycle, and wherein the sustained Stirling cycle lasts for at least 100 hours.
